(19) United States
(12) Patent Application Publication
(10) Pub. No.: US 2011/0082855 A1
(43) Pub. Date: Apr. 7, 2011

(54) MULTI-DIMENSIONAL ACCESS TO DATA

(76) Inventors: Awny K. Al-Omari, Cedar Park, TX (US); Robert M. Wehrmeister, Austin, TX (US)

(21) Appl. No.: 12/571,691

(22) Filed: Oct. 1, 2009

(51) Int. Cl. G06F 7/10; G06F 17/30

(52) U.S. Cl. 707/715; 707/E17.005; 707/E17.014; 707/E17.044

(57) ABSTRACT

One embodiment includes dimensional columns of a database table that are mapped to filter columns. The filter columns are used to build an index which provides multi-dimensional access to the database table.

### BACKGROUND

The amount of data stored in data warehousing systems has been continuously increasing over the last few decades. Database management systems manage large volumes of data that need to be efficiently accessed and manipulated.

A growing challenge of data warehousing systems that support Business Intelligence (BI) applications is to support ever more complex queries that access ever more data while improving query performance. Queries used by BI applications can be characterized as being complex queries that access the data along many different dimensions and which also access a large amount of data. However, the typical structure used to organize data in a data warehouse system is the B-tree which does not typically support multi-dimensional access.

### BRIEF DESCRIPTION OF THE DRAWINGS

FIG. 1 shows a method for providing multi-dimensional access to data stored in a data warehousing system without the use of secondary indexes in accordance with an example embodiment.

FIG. 2 shows a method for using multi-dimensional partitioning to execute a query in accordance with an example embodiment.

FIG. 3 shows a multi-dimensional partitioning layout for three filter columns, each using a base value of 3, in accordance with an example embodiment.

FIG. 4 shows a database system for managing the execution of database queries in accordance with an example embodiment.

FIG. 5 shows a block diagram of an example computer system in accordance with an example embodiment.

### DETAILED DESCRIPTION

One embodiment uses Multi-Dimensional Partitioning (MDP) to organize data in data warehousing systems. As explained in more detail below, the dimensional columns (D1, D2, . . . , DN) of a database table are mapped to artificial filter columns (Filter_D1, Filter_D2, Filter_DN), each with a small unique entry count (UEC). A B-tree clustering index is then constructed using these filter columns as the clustering key. Using this B-tree structure and an iterator, queries containing predicates on one or more of the dimensional columns (D1, D2, . . . , DN) can be satisfied by scanning only a portion of the database table.

Overview

In large multi-dimensional databases and data warehousing systems, data is stored in tables which are retained as continuous files in storage devices, such as hard disks. An indexing scheme is built on top of the database to assist in finding specific data located in the hard disks. Tables are indexed and ordered in a particular way or dimension. Many tables in databases are organized along a single dimension or configuration, such as being organized along a single column (for example, column A is designated as a clustering key). For example, a table storing information on employees in a company can be organized along one dimension according to a social security number for each employee. Tables can also be organized along multiple columns (for example, columns A and B are designated as a clustering key). For example, a table storing information on employees in a company can be organized along a composite of two dimensions according to employee name, then according to employee department. Using this organization, access to such a table can be via employee name or via the composite of employee name and employee department. Access to the table, however, cannot occur along employee department alone.

Tables can also be indexed with secondary indexes. Secondary indexes are alternative B-trees with references back to the rows in the underlying data. For example, a primary clustering index built on names of employees contains a B-tree organized by name with references to rows in the underlying data; and a secondary index built on social security numbers of the employees contains a B-tree organized by social security number with references to the rows in the underlying data. Typically, the underlying data is ordered based on the columns of the primary index. So the references in the primary index are stored in the same order as the referenced data. However, the references in a secondary index are stored in a different order than the referenced data. So a range of references of the secondary index will refer to a set of rows randomly distributed within the underlying data.

Secondary indexes are effective when accessing a small number of rows, but much less effective when accessing many rows. After accessing the index, the qualifying rows are fetched from the underlying data. Since the secondary indexes are organized along a different dimension than a primary index, the access to the data is likely to be random and hence slow since an actuator arm of the hard disk drive moves across multiple locations on the disk. It does not take many random fetches before the performance of the index exceeds the performance of simply scanning all the data of the database table.

Example embodiments enable efficient access to data through multiple dimensions without having multiple indexes (for example, without requiring or using secondary indexes). A single clustering index is built, and this index is searched along multiple dimensions to provide access to data without searching entire contents of a table. For example, a file structure organized in multiple dimensions (such as social security numbers for employees, employee name, and employee department) can be efficiently searched according to any combination of these dimensions. For example it can be efficiently searched by social security number alone or by employee name alone or by employee department alone or any combination of the three dimensions.

Example embodiments create new filter columns wherein each dimension of the multiple dimension data is mapped to a new coarser grained dimension. Using a many-to-one mapping, each value of a dimensional column is mapped to one of the values or buckets of the filter column. The following example illustrates a many-to-one mapping: All employee last names that begin with the letter “A” are mapped to an A-bucket; all employee last names that begin with the letter “B” are mapped to a B-bucket; . . . all employee last names that being with the letter “Z” are mapped to a Z-bucket.

In the example, all names are mapped to one of twenty six buckets, with each bucket representing a letter in the alphabet. Example embodiments are not limited to using a filter that maps names based on a letter in the alphabet. As explained more fully below, example embodiments include a hash filter that hashes a value and then performs a modulo operation on the hashed value. Another embodiment includes a range filter that designates a set of first numbers or letters as range 1, a second set of numbers or letters as range 2, etc. to range n. Any many-to-one function can be used as a mapping filter.

Example embodiments build a composite structure from respective filters. A composite structure is built for a filter for A, a filter for B, a filter for C, etc. For example, a composite structure is built for a filter for names of employees, a filter for employee social security numbers, etc.

An iterator, such as a multi-dimensional access method, is then applied to the composite structure. For instance, a table for employees in a company can be clustered by the filter for employee name (which for example uses the first alphabetical letter and hence has twenty six buckets) and the filter for social security numbers (which for example uses the value of the ninth digit and hence has ten buckets: a first bucket for social security numbers beginning with the number 0; a second bucket for the social security numbers beginning with the number 1; . . . a tenth bucket for the social security numbers beginning with the number 9). To search for a specific employee name, such as “Smith, John”, the search is directed to the S-bucket without scanning the full table. Although this avoids scanning the full table, this is actually a regression in performance as compared to a traditional B-tree index on employee name and social security number. In a traditional B-tree, access via the employee name would scan only those records having the given employee name (as opposed to all the record with names having the same first letter).

In contrast to the traditional B-tree index, one embodiment uses MDP to provide access via subsequent columns. MDP sacrifices some performance of access via the leading key column but gains enormous performance of access via subsequent key columns. To search for a specific social security number (such as a social security number beginning with the number 3), an iteration is performed over each of the alphabetical buckets for a social security number beginning with the number 3. This iteration is limited to columns having the social security numbers beginning with 3 in each of the alphabetical buckets. Even though each of the twenty-six alphabetical buckets may be searched, only one-tenth ( 1/10^{th}) of the total search space for each alphabetical bucket is actually searched (assuming for this illustration that the buckets are equally sized). In other words, one-tenth ( 1/10^{th}) of the entire table is searched. Using a traditional B-tree, access via the social security number would result in scan of the entire table.

The number of dimensions and/or filter functions is not limited to any particular number. The number of filter functions and/or the filter criteria can vary and depends on, for example, the number of seeks required to find the data, the cost of each seek, the size of data being stored or the file size, type of queries and frequency of access along different dimensions, etc. In one example embodiment, the number of filter functions is determined based on a comparison of the time to perform a given number of seeks versus the time required to scan the whole table (the time to perform the seeks should be less than the time to scan the entire table). Further, the number of buckets can vary depending on how the data is distributed in the buckets (for example, is the data uniformly distributed in the buckets or do some buckets have more data than others).

Preferably, the time to perform a given number of seeks should not be greater than the time to search the entire search space. By way of example, suppose ten dimensions or filters are selected for stored data. Here, a search to the first dimension is performed with one seek (i.e., the search goes directly to the desired bucket). A search to the second dimension would iterate over the first dimension and would involve B₁ seeks (i.e., assuming the first dimension has B₁ different buckets to search). A search of the third dimension would iterate over both the first and second dimensions and would involve up to B₁*B₂ seeks (i.e., assuming the second dimension has B₂ different buckets to search). A search to the fourth dimension would iterate over the first, second, and third dimensions and would involve up to B₁*B₂*B₃ seeks.

As explained more fully below, the number of seeks is bounded by the following:

$${B}_{1}^{*} {B}_{2}^{*} {B}_{3} … {B}_{N - 1} = {\prod }_{i = 1}^{N - 1} {B}_{i} .$$

For simplicity, assume B₁=B₂=B₃=Bᵢ=B. Then the number of seeks is bounded by B^{(N-1)}, where B is the base (i.e., the number of buckets) for each dimension and N is a number of the dimension being searched. Thus, the time to perform B^{(N-1)} seeks should be less than the time required to scan the entire table. This number (B^{(N-1)}) can be used to determine the total number of dimensions and/or the bases (Bᵢ) of the filter functions. In practice, each dimension can have a different value for B and B^{(N-1)} is replaced by

$${\prod }_{i = 1}^{N - 1} {B}_{i} .$$

Discussion of Figures

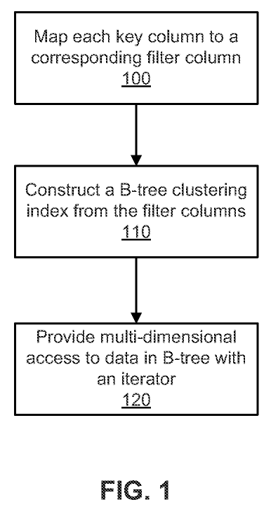

FIG. 1 shows a method for providing multi-dimensional partitioning access to multi-dimensional data stored in data warehousing systems.

According to block 100, each dimensional column of a table is mapped to a newly created filter column. By way of example, assume we want to construct a multi-dimensional access on dimensional columns D1, D2 . . . DN in a database table. A many-to-one mapping is used to map each of the dimensional columns into a corresponding new artificial filter column. The new filter columns each have a small unique entry count (UEC), and the values in each dimensional column are uniformly mapped to values of the corresponding filter column. For example, the following maps a column D into a computed column Filter_D such that the values of D range from 0 to 9 and the UEC of the new column is at most 10 (i.e., less than or equal to 10):

Filter_{—}D=Map(D→0 . . . 9)=hash(D)%10.

The values of D are uniformly mapped to the 10 values (buckets) of Filter_D with a hashing function (such as an order preserving hashing function) or a balanced partitioning function. We refer to the number of values of a filter column as the base B. In principle, the different key columns are mapped using different mapping functions and different B values (i.e., the mappings of the different columns are orthogonal).

According to block 110, a B-tree index is constructed or built from the filter columns. For example, a traditional B-tree clustering index is then constructed using (Filter_D1, Filter_D2, . . . Filter_DN) as the composite clustering key. This index is keyed with low UEC filter columns which allow example embodiments to use this clustering index for dimension lookup on any of the filter columns with a relatively small number of seeks using an iterator.

According to block 120, an iterator provides multi-dimensional access to data in the B-tree. The following example illustrates the use of the iterator with the constructed B-tree.

A B-tree is a tree data structure in a database that organizes data and enables one dimensional access to data through searches, insertions, and deletions. Internal nodes have a variable number of child nodes with all leaf nodes (i.e., external nodes) being maintained at a same depth for balance. A given B-tree can be organized to provide access along one dimension based on a key defined for the B-tree. The key for the B-tree can be defined based on multiple columns, but a particular order of the columns is followed. For example, if the key is defined to be (D1, D2, D3), the B-tree provides access based on (D1), (D1, D2) or (D1, D2, D3). The B-tree, however, does not provide access based on (D3) or (D2, D3) for example. In these cases, the B-tree is not utilized and the query resorts to scanning all the data. Thus, only one dimensional access to the data is provided.

As noted, the iterator provides multi-dimensional access to the data via a single B-tree. For example, when accessing a B-tree based on the second column (D2) of the key (D1, D2), the iterator iterates through all the distinct values of the first column (D1) and performs a separate search on (D1, D2) for each distinct value of D1 and the requested value of D2. If there are N distinct values of D1, there will be N searches. The iterator provides better results when the number of distinct values (UEC for Unique Entry Count) of the key columns is relatively low. When the UEC is high, the performance of iterator is dominated by the overhead of doing many separate searches and can exceed that of a scan of all the data. The overhead for each search includes the time spent traversing the B-tree and potentially the time of a disk seek.

Example embodiments are not limited to any specific type of iterator. One example iterator is disclosed in U.S. Pat. No. 5,778,354 entitled “Database Management System with Improved Indexed Access” which is incorporated herein by reference. Other iterators include, but are not limited to, a counter iterator, a nested loop join, and other device that repeatedly go through data.

Effectively, the B-tree is now partitioned at multiple levels. At the highest level the index is partitioned into B1 partitions on Filter_D1. Each of the first level partitions itself is partitioned into B2 partitions on Filter_D2. The partitioning continues recursively up to the last filter column, Filter_DN. These multi-dimensional partitions are referred to as partitions, which should not be confused with traditional partitions that distribute the table's data across different files or disks. Note that since the filter columns have low UEC values, they can be stored in just a few bits each and result in very little space overhead.

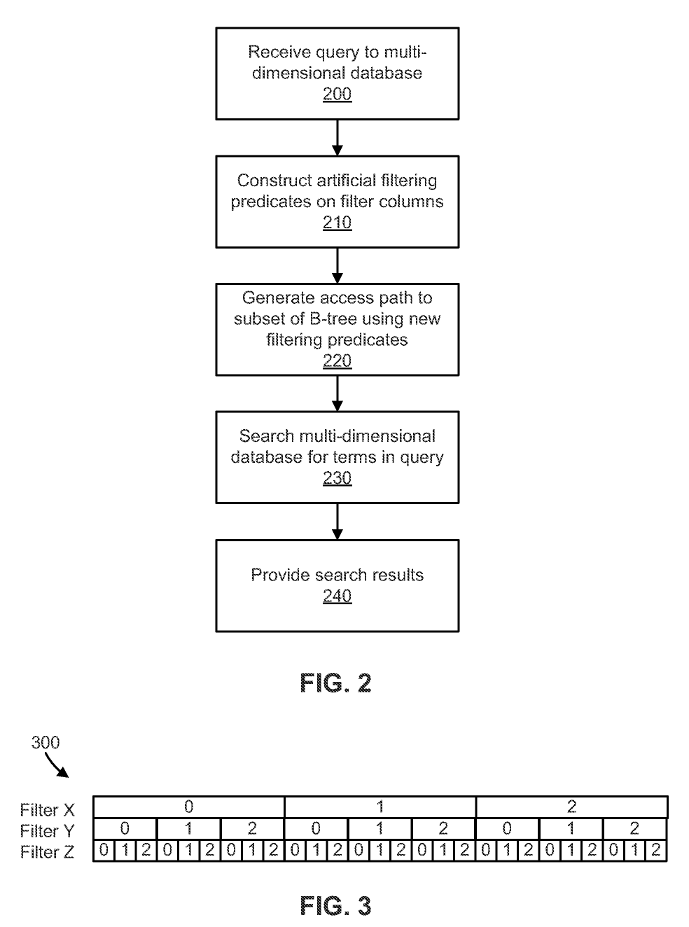

FIG. 2 shows a method for using multi-dimensional partitioning to execute a query in accordance with an example embodiment.

According to block 200, a query is received to be executed at a multi-dimensional database. For example, a user presents a query or search terms in the form of a Structured Query Language (SQL) statement to extract selected portions of stored data in a multi-dimensional database.

According to block 210, artificial filtering predicates are added on the filter columns. When a compiler receives a query that has predicates on any of the dimensional columns (D1 DN), the compiler adds artificial filtering predicates on the corresponding filter columns. For example, for (Di=<constant>) the compiler introduces an additional predicate (Filter_Di=Mapi(<constant>)). Similarly if an order preserving mapping function is used such as range partitioning or order preserving hash; then for (Di><constant>) or (Di<<constant>), the compiler adds (Filter_Di>=Mapi(<constant>)) or (Filter_Di<=Mapi(<constant>)), respectively.

According to block 220, an access path to a subset of the B-tree is generated using the new filtering predicates. The path provides access to a subset of the B-tree file using the new filtering predicates on the low UEC filtering keys. The matching set defined by the query's original predicates is within the scanned subset which is further refined based on the original predicates.

According to block 230, the database is searched for the terms or keywords in the query. After the user inputs an SQL query into the computer, an SQL compiler develops an efficient or optimal plan to extract the desired information from the database using the generated B-tree.

Typically, the SQL compiler converts the SQL statement into a number of relational operators stored in computer memory to form the query tree. Each node of the tree represents a relational operator, such as a “sort” or “merge” operator. The optimizer portion of the compiler explores a large number of different logically equivalent forms of the query tree, called “plans”, for executing the same query. The DBMS selects a query plan with a lowest estimated cost (i.e., lowest amount of computer resources utilized by the computer in executing the SQL statement and consider such factors as the number of I/O's or CPU instructions).

According to block 240, results of the query are provided to a user, transmitted, stored, or used for further processing. For example, the results of the query are displayed to the user on a display, stored in a computer, or provided to another software application.

FIG. 3 shows a multi-dimensional partitioning layout 300 for three filter columns with each column using a base value of B=3. As shown, the index is partitioned recursively 3-ways on Filter_X, Filter_Y, and Filter_Z for a total of 27 partitions. The number of partitions in FIG. 3 is presented as an illustration. A large multi-dimensional database will have a much larger number of partitions.

By way of example, assume an embodiment with a predicate (X=3947) for which the compiler would add a filter predicate (Filter_X=Map(3947)=1 (i.e. assume Map(3947) evaluates to 1)). Only one-third of the table would be scanned, namely the nine adjacent partitions (1, 0-2, 0-2 (i.e. the nine adjacent partition illustrated in FIG. 3 defined by Filter_X=1; Filter_Y between 0 and 2; Filter_Z between 0 and 2)). A similar scenario for a predicate on column Y would result in scanning nine partitions; three groups of three adjacent partitions (0-2, 1, 0-2). Typically this requires three seeks in addition to the scan of one-third (⅓) of the table. A similar scenario for a predicate on column Z results in scanning nine non-adjacent partitions (0-2, 0-2, 1) which has the cost of nine seeks and a scan of one-third (⅓) of the table. If the query has the aforementioned predicates on both Y and Z, then only three non-adjacent partitions (0-2, 1, 1) are scanned which is one-ninth ( 1/9) of the table. Similarly a query with predicates on X, Y, and Z results in scanning only one partition (i.e., one-twenty-seventh ( 1/27) of the table).

The cost of the MDP scan can be broken into two components: (1) the cost of the table subset sequential scans, and (2) the cost of input/output (I/O) seeks to position to non-adjacent partitions. While increasing the number of partitions reduces the average partition size and reduces the cost of the subset sequential scan, it increases the cost of the seeks. Assuming N dimensional columns and a base value of B used for mapping, the maximum number of non-adjacent partitions is B^{(N-1)}. This number implies that in order for the cost of the maximum potential number of seeks in an MDP scan not to exceed the cost of a full table scan, the value of B should not exceed (FS/SC)^{1/(N-1)}, where FS is the cost of the full table scan and SC is the average cost of a single seek. An even safer limit is to make B<(FS/2SC)^{1/(N-1)}. This base value puts a limit to the cost of seeks to be less than half (½) of the cost of the full table scan and assists in obtaining an improved MDP scan.

Assume an example having a file size of 2 GB, a sequential scan speed of 100 MB/s, and an average seek cost of 5 milliseconds. Here, 4 dimensional columns results in a good value of B˜12.

In the previous example, a constant value of B was used for all filter columns. It is, however, possible to use different B values for different filter columns. The restriction remains that the value of B₁×B₂× . . . B_{N-1} should not exceed FS/2SC in order to ensure a sufficient access path is provided up to the last dimensional column DN. Allocating different B values for different filter columns enables focus on some of the more interesting dimensional columns over others. For example, if column D1 is much more frequently queried than column D2, the physical schema designer or administrator can set a higher value for B₁ than B₂. This will result in an improved selectivity and resolution for queries using Filter_D1 over queries using Filter_D2.

The choice of a good mapping function achieves a better overall performance and dimensional coverage for MDP. In one embodiment, a good mapping uniformly maps the column values to filter values in order to achieve more uniform data distribution among the partitions. If the dimensional column is queried by equality predicates mainly such as (Di=<constant>), then one embodiment uses of a hash function as the mapping function. A good hash function assumes uniform distributions of the values and requires zero maintenance. If the dimensional column is queried by range predicates such as (Di><constant>) as well as equality predicates, then one embodiment uses a balanced range partitioning function for mapping. This function can handle both equality and range queries but requires the designer to define the boundaries between the partitions in order to assure uniformity.

As noted, example embodiments of MDP can be used with multi-dimensional databases. MDP can have an even larger impact when used with solid-state storage devices, such as Flash Drives. Since the performance of MDP is limited by the costs of disk seeks, MDP should have even better performance improvements when using devices with very low seek costs.

Compared to traditional B-tree access, MDP shows superior performance in example embodiments. Secondary indexes are not required and add to storage cost (i.e., require more disk space and maintenance and they do not perform well when accessing a large number of rows as required for analytical queries).

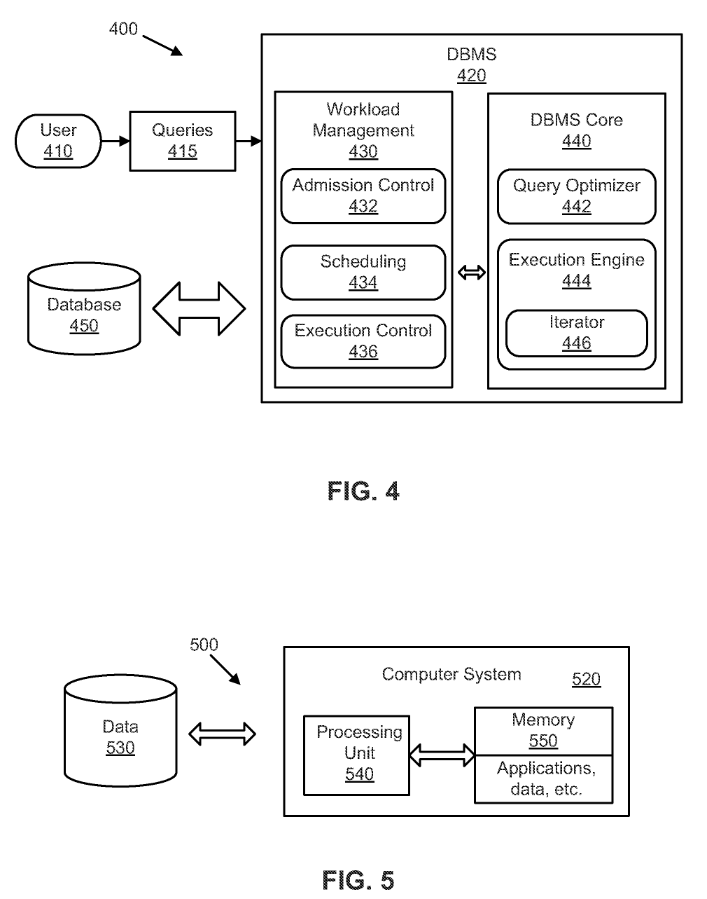

FIG. 4 is a database system 400 for managing the execution of database queries and query plans in accordance with an example embodiment.

The system generally includes a computer, client, or user 410 that sends queries 415 to a Database Management System (DBMS) 420 which includes a workload management component 430 and a DBMS core 440. The workload management component includes plural components or modules, such as admission control 432, scheduling 434, and execution control 436. The DBMS core 440 includes plural components or modules, such as a query optimizer 442, and an execution engine 444. The execution engine includes plural components or modules, such as an iterator 446.

The workload management architecture 430 provides fundamental workload management functionality for admission control, scheduling, and execution control. In one embodiment, each of these modules 432, 434, and 436 can be adjusted to select from a variety of workload management policies and algorithms.

In one embodiment, the database system executes workloads that include one or more jobs or queries. Each job consists of an ordered set of typed queries 415 submitted by the computer or user 410 and can be, for example, associated with one or more Service Level Objectives (SLOs). Each query type maps to a tree of operators, and each operator in a tree maps in turn to its resource costs.

Policies of the admission control 432 determine the submission of queries 415 to the execution engine 444 that executes the submitted queries. The admission control 432 performs several functions in workload management. First, when a new job arrives, admission control 432 evaluates the DBMS's multiprogramming level, and either submits or enqueues each of the job's queries. Second, the architecture is configurable to support multiple admission queues. Policies of the admission control 432 regulate the distribution of queries among these queues, for example adding queries to queues based on estimated cost or dominant resource. Third, when the execution engine 444 has finished processing a query, admission control 432 selects the next query for execution.

Once queries have been queued, the policies of the scheduler 434 determine the ordering of the queries within a queue (for example, by estimated cost). Policies of the execution control 436 then govern the flow of the running system to one or more processors or central processing units (CPUs). Data is retrieved from a warehouse or database 450, such as a multi-dimensional database.

When compared with one-dimensional access provided with a traditional B-tree, multi-dimensional partitioning with example embodiments provides enhanced performance to large amounts of data along multiple dimensions. By way of example, one embodiment gives a ten-fold improvement in performance over B-tree for equality predicates and a five-fold improvement for range predicates for a typical sized business intelligence (BI) table.

Example embodiments are utilized in or include a variety of systems, methods, and apparatus. FIG. 5 illustrates an example embodiment as a computer system 500 for being or utilizing one or more of the computers, methods, flow diagrams and/or aspects of example embodiments.

The system 500 includes a computer system 520 (such as a host or client computer) and a repository, warehouse, or database 530. The computer system 520 comprises a processing unit 540 (such as one or more processors of central processing units, CPUs) for controlling the overall operation of memory 550 (such as random access memory (RAM) for temporary data storage and read only memory (ROM) for permanent data storage). The memory 550, for example, stores applications, data, control programs, algorithms (including diagrams and methods discussed herein), and other data associated with the computer system 520. The processing unit 540 communicates with memory 550 and data base 530 and many other components via buses, networks, etc.

Example embodiments are not limited to any particular type or number of databases and/or computer systems. The computer system, for example, includes various portable and non-portable computers and/or electronic devices. Example computer systems include, but are not limited to, computers (portable and non-portable), servers, main frame computers, distributed computing devices, laptops, and other electronic devices and systems whether such devices and systems are portable or non-portable.

### DEFINITIONS

As used herein and in the claims, the following words have the following definitions:

The terms “automated” or “automatically” (and like variations thereof) mean controlled operation of an apparatus, system, and/or process using computers and/or mechanical/electrical devices without the necessity of human intervention, observation, effort and/or decision.

The term “Business Intelligence” or “BI” means technologies, applications, and practices for the collection, integration, analysis, and presentation of business information to improve business decision making.

A “database” is a structured collection of records or data that are stored in a computer system so that a computer program or person using a query language (such as SQL) can consult it to retrieve records and/or answer queries. Records retrieved in response to queries provide information used to make decisions. Further, the actual collection of records is the database, whereas the DBMS is the software that manages the database.

A “database management system” or “DBMS” is computer software designed to manage databases.

A “dimension” is a data element that categorizes each item in a data set into non-overlapping regions. For example, products, regions, customer names, dates, etc. can all represent different dimensions.

A “clustering key” is a table column or set of columns that define how the data is physically organized on disk.

A “key” is a column of records in a database table.

The term “multidimensional database” is a database wherein data is accessed or stored with more than one attribute (a composite key). Data instances are represented with a vector of values, and a collection of vectors (for example, data tuples) are a set of points in a multidimensional vector space. Dimensional databases represent data entities as different dimensions (as opposed to representing data as multiple relations in a relational database).

The term “modulo” is a mathematical operation that finds a remainder of division of two numbers. For example, given x (a dividend) and y (a divisor), x modulo y (abbreviated as x mod n) is the remainder on a division of x by n. The expression “8 mod 3” evaluates to 2; while the expression “9 mod 3” evaluates to 0.

A “predicate” is an operation that specifies a comparison between two values, such as equal to, greater than, not equal to, greater than or equal to, less than or equal to, less than, etc.

A “primary key” is a table column or set of columns that uniquely identifies each record in the table. The primary key values are unique and do have duplicates within the same table.

A “query” is a request for retrieval of information from a database.

A “query optimizer” is a component of a database management system (DBMS) that attempts to determine the most efficient way to execute a query. Query optimizers evaluate different possible query plans for a given input query and determine which of those plans is most efficient. Cost-based query optimizers assign an estimated “cost” to each possible query plan, and choose the plan with the smallest cost. Costs are used to estimate the runtime cost of evaluating the query, in terms of the number of I/O operations required, the CPU requirements, and other factors. The set of query plans examined is formed by examining the possible access paths (e.g. index scan, sequential scan) and join algorithms (e.g., sort-merge, hash join, nested loops).

A “query plan” is a set of steps used to access information in database management system. For example, in an SQL database, multiple alternate ways with varying performance exist to execute a given query. When a query is submitted to the database, a query optimizer evaluates some of the different possible plans for executing the query and returns one or more possible results.

A “table” when used in the context of a database is a logical representation of data in a database in which a set of records is represented as a sequence of rows, and the set of fields common to all the records is represented as a series of columns. The intersection of a row and column represents the data value of a particular field of a particular record. The columns are identified by name, and the rows are identified by values in a particular column subset which is identified as a candidate key.

“Structured Query Language” or “SQL” is a database computer language designed for the retrieval and management of data in a relational database management system, database schema creation and modification, and database object access control management. SQL provides a programming language for querying and modifying data and managing databases (for example, retrieve, insert, update, and delete data, and perform management and administrative functions.

A “unique entry count” or “UEC” is the number of unique values within a column of a table.

In one example embodiment, one or more blocks or steps discussed herein are automated. In other words, apparatus, systems, and methods occur automatically.

The methods in accordance with example embodiments are provided as examples and should not be construed to limit other example embodiments. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit example embodiments.

Embodiments are implemented as a method, system, and/or apparatus. As one example, example embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known physical and tangible media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various example embodiments. Numerous variations and modifications will become apparent to those skilled in the art once the above disclosure is fully appreciated. It is intended that the following claims be interpreted to embrace all such variations and modifications.

What is claimed is:

1) A method executed by a computer, comprising:
mapping dimensional columns of a database table to filter columns;
building an index using the filter columns as a clustering key;
receiving a query having predicates on any combination of the dimensional columns;
generating predicates on the filter columns; and
using the index to provide multi-dimensional access to the database table to satisfy the query without using multiple or secondary indexes.

2) The method of claim 1 further comprising, searching the database table along each of the plurality of the dimensional columns alone and composites of the plurality of the dimensional columns to discover data according to the query.

3) The method of claim 1 further comprising, reading through only a fraction of the database table to discover data according to the query.

4) The method of claim 1 further comprising, constructing the index as a B-tree.

5) The method of claim 1, wherein the filter columns are generated from a filter operation that is a many-to-one mapping that maps dimensional column values to a smaller number of filter column values.

6) The method of claim 5, wherein the many-to-one mapping is a hashing function.

7) The method of claim 6, wherein the hashing function is an order preserving hashing function.

8) The method of claim 5, wherein the many-to-one mapping is a range distribution function that maps consecutive intervals of the dimensional column values to a sequence of interval numbers.

9) A tangible computer readable storage medium having instructions for causing a computer to execute a method, comprising:
mapping, with many-to-one mappings, multiple dimensional columns in a database table to plural filter columns;
constructing an index using the plural filter columns as a clustering key;
generating predicates on the filter columns; and
searching the index along multiple dimensions to provide access to data stored in a database without reading entire contents of the database table.

10) The tangible computer readable storage medium of claim 9, wherein the many-to-one mappings use a hashing function.

11) The tangible computer readable storage medium of claim 9, wherein the many-to-one mappings use a range distribution function.

12) The tangible computer readable storage medium of claim 9, wherein the index provides multi-dimensional access to the data without using secondary indexes.

13) The tangible computer readable storage medium of claim 9 further comprising, searching the database table along each of the multiple dimensional columns alone and composites of the multiple dimensional columns to discover data according to a query.

14) The tangible computer readable storage medium of claim 9 further comprising, reading through only a portion of the database table to discover data according to a query.

15) A computer system, comprising:
a multi-dimensional database that stores data; and
a computer that:
maps dimensional columns of a database table to filter columns;
constructs an index using the filter columns as a clustering key;
receives a query having predicates on a plurality of the dimensional columns;
generates predicates on the filter columns; and
iterates through a portion of the index along multiple dimensions to provide access to the data and satisfy the query without reading entire contents of the database table.

16) The computer system of claim 15, wherein values in the dimensional columns are mapped to values in the filter columns with a hash function.

17) The computer system of claim 15, wherein values in the dimensional columns are mapped to values in the filter columns with a range distribution function.

18) The computer system of claim 15, wherein the computer scans only a portion of the index, as opposed to a full scan of the database table, to access the data and satisfy the query.

19) The computer system of claim 15, wherein a time to perform seeks through the filter columns is less than a time to perform a full scan of the database table.
